(19) United States
(12) Patent Application Publication
(10) Pub. No.: US 2006/0182573 A1
(43) Pub. Date: Aug. 17, 2006

(54) Hoist and transport apparatus

(75) Inventor: Edgar Taylor, Anderson, CA (US)

Correspondence Address: THOMAS R. LAMPE, SUITE 1020, 1390 WILLOW PASS ROAD, CONCORD, CA, 94520, US

(73) Assignee: LIFTOFF SYSTEMS, INC.

(21) Appl. No.: 11/029,771

(22) Filed: Jan. 5, 2005

(51) Int. Cl. B60P 1/04

(52) U.S. Cl. 414/477

(57) ABSTRACT

Hoist and transport apparatus for a pick-up truck includes a carrier and a transport assembly for moving the carrier between a position on the pick-up truck and a position to the rear of the pick-up truck. When on the pick-up truck the carrier and any objects supported thereby are located over the cargo compartment of the pick-up truck.

### TECHNICAL FIELD

This invention relates to apparatus for use with a pick-up truck utilized to hoist and transport one or more objects. For example, the apparatus may effectively be utilized to carry all terrain vehicles, personal watercraft and other types of equipment. The apparatus also can be utilized to hoist and transport a great many other types of goods and materials.

### BACKGROUND OF THE INVENTION

Power and load lifters of various types are known in the prior art, some of these being utilized in connection with trucks, including pick-up trucks. U.S. Pat. No. 3,885,686, issued May 27, 1975, discloses a lifting and loading apparatus to be used in connection with vehicles, for example pick-up trucks, to load heavy articles. The load is transported and placed directly onto the bed of the pick-up truck. This means that the normal cargo space defined by the bed, sidewalls and tailgate of the truck cannot be utilized.

U.S. Pat. No. 6,019,567, issued Feb. 1, 2000, discloses a slidable load lift apparatus selectively completely retractable into the bed of a standard pick-up truck. Here too, the cargo compartment of the pick-up truck is utilized to accommodate both the apparatus and the load.

The following patent publications also disclose various hoist and transport systems utilized in connection with trucks and other vehicles and are believed to be further representative of the current state of the prior art: U.S. Pat. No. 4,930,972, issued Jun. 5, 1990, U.S. Pat. No. 5,651,657, issued Jul. 29, 1997, U.S. Pat. No. 4,278,390, issued Jul. 14, 1981, U.S. Pat. No. 3,716,151, issued Feb. 13, 1973, U.S. Pat. No. 5,556,250, issued Sep. 17, 1996, U.S. Pat. No. 5,110,252, issued May 5, 1992, U.S. Pat. No. 3,351,220, issued Nov. 7, 1967 and European Patent Application No. 0 080 989.

None of the arrangements of the known prior art teach or suggest the unique combination of structural elements and cooperative relationships disclosed and claimed herein.

### DISCLOSURE OF INVENTION

The present invention relates to a unique hoist and transport apparatus for use with a pick-up truck. The apparatus may readily be installed as a unit or removed from the truck as a unit. When the apparatus is employed, the cargo compartment of can be readily accessed through the tailgate of the pick-up truck in a conventional manner.

The hoist and transport apparatus of the present invention includes a carrier including a carrier platform for carrying one or more objects.

The apparatus also includes a transport assembly operatively associated with the carrier when said transport assembly is attached to the pick-up truck to move said carrier along with any objects on said carrier between a first carrier position wherein said carrier along with any objects thereon is located above the bed and cargo compartment of the pick-up truck, elevated relative to the bed and positioned relative to the tail gate allowing the tail gate to be opened to provide access to the cargo compartment or to be closed and a second carrier position wherein said carrier along with any objects thereon is displaced in a rearward direction relative to the pick-up truck to uncover the cargo compartment and position the carrier on the ground or other surface rearwardly of the pick-up truck. The transport assembly includes a pair of spaced support rails elevated relative to the bed of the pick-up truck and extending along the sidewalls thereof when said transport assembly is attached to the pick-up truck.

Other features, advantages and objects of the present invention will become apparent with reference to the following description and accompanying drawings.

### BRIEF DESCRIPTION OF DRAWINGS

FIG. 1 is a perspective view of apparatus constructed in accordance with the teachings of the present invention installed at the back of a pick-up truck, an all terrain wheeled vehicle supported by the carrier of the apparatus being shown in phantom lines;

FIG. 2 is a view similar to FIG. 1 without the depiction of the all terrain vehicle and illustrating the carrier elevated slightly and partially displaced in a rearward direction;

FIG. 3 is an enlarged, elevational view of that portion of the apparatus delineated by line 3-3 in FIG. 1 and showing two different orientations of the distal end of a support arm incorporated in the structure, one position being shown in solid lines and the other position shown in dash lines;

FIG. 4 is a greatly enlarged, cross-sectional view taken along the line 4-4 of FIG. 2;

FIG. 5 is an enlarged, elevational view of that part of the apparatus delineated by line 5-5 in FIG. 12;

FIG. 6 is a view similar to that of FIG. 2, but showing the transport assembly base of the apparatus displaced rearwardly along with the elevated carrier supported thereby;

FIG. 7 is a view similar to FIG. 6, but illustrating the support arms of the apparatus pivoted to a substantially horizontal position to fully displace the carrier rearwardly of the truck for positioning on the ground or other support surface;

FIG. 8 is a greatly enlarged, perspective view illustrating details of selected structural portions of the apparatus in the operating condition shown in FIG. 7;

FIG. 9 is an elevational, cross-sectional view illustrating details of support structure for supporting the carrier when in the position of FIG. 1;

FIG. 10 is a view similar to FIG. 9, but illustrating the relationship between the carrier and the support structure when the carrier is in the position of FIG. 11;

FIG. 11 illustrates the carrier in an inclined condition extending between the pick-up truck and a support surface, the carrier having been tilted to such position without the transport assembly base having been transported in a rearward direction;

FIG. 12 is a perspective view of the hoist and transport apparatus, but with the solid platform shown in FIGS. 1-11 removed and the platform consisting of an open framework;

FIG. 13 is a view similar to FIG. 1, but illustrating an embodiment of the invention wherein the carrier platform comprises an open framework and wherein the apparatus incorporates stabilizers engageable with the hull of a personal marine watercraft, the latter shown in phantom lines;

FIG. 14 is a side, elevational view of the embodiment of the apparatus of FIG. 13 in place on the back of a pick-up truck and the personal watercraft being shown in phantom lines;

FIGS. 15, 16 and 17 are greatly enlarged, perspective views of selected portions of components of the embodiment of FIG. 13, including a support arm and carrier linkage, shown in alternative relative positions assumed thereby during operation of the apparatus;

FIG. 18 is a perspective view of the apparatus of FIG. 13 with the carrier thereof fully extended and displaced rearwardly of the pick-up truck;

FIG. 19 illustrates the embodiment of FIG. 13 in the position shown in FIG. 18 being utilized to float the personal watercraft on the surface of a body of water;

FIG. 20 illustrates a third embodiment of the apparatus which utilizes a different form of carrier, FIG. 20 corresponding in nature to FIGS. 1 and 13;

FIG. 21 is a view similar to FIG. 20, but illustrating the carrier on the third embodiment displaced to the rear of the pick-up truck for positioning on the ground;

FIG. 22 is a somewhat diagrammatic presentation illustrating the distal end of a support arm and the carrier of the third embodiment supported thereby;

FIG. 23 is a view similar to FIGS. 1, 13 and 20, but illustrating a fourth embodiment of the invention incorporating yet another form of carrier; and

FIG. 24 illustrates the carrier of the fourth embodiment positioned on a trailer located behind the associated pick-up truck.

### MODES FOR CARRYING OUT THE INVENTION

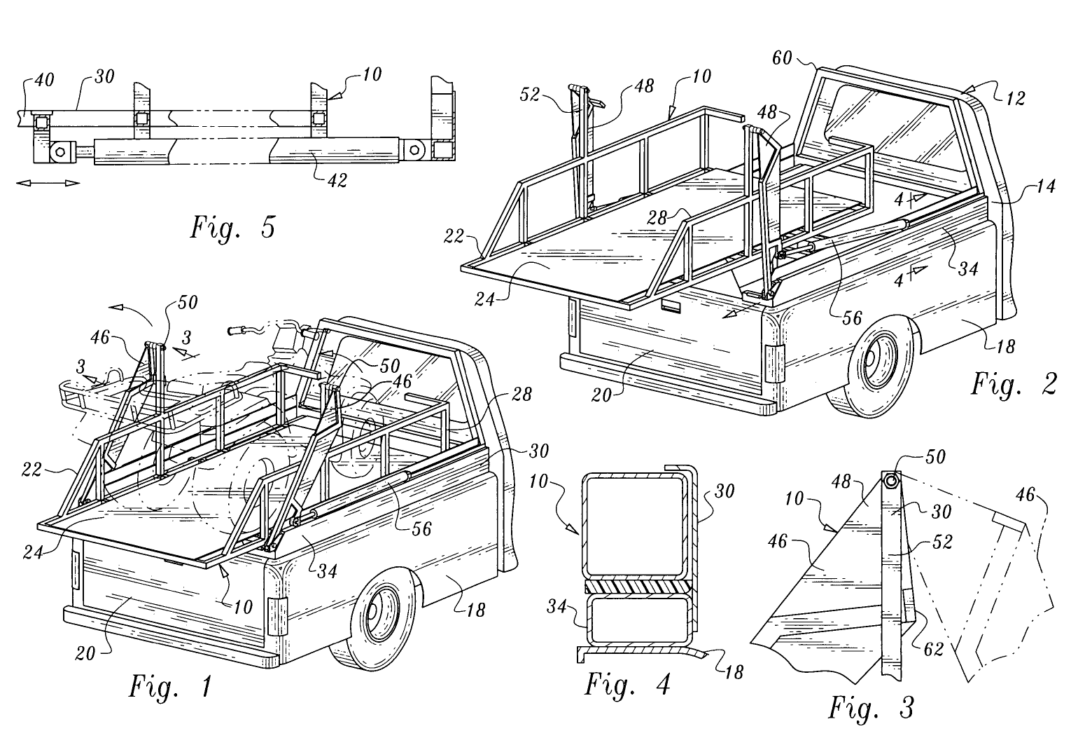

FIGS. 1-12 illustrate a preferred embodiment of the present invention, a hoist and transport apparatus designated by reference numeral 10. Apparatus 10 is illustrated as employed on a pick-up truck 12 of conventional construction, including a cab 14, a bed 16, a pair of spaced sidewalls 18 extending upwardly from the bed, and a tailgate 20. The bed, sidewalls and tailgate, as is conventional, define a pick-up truck cargo compartment.

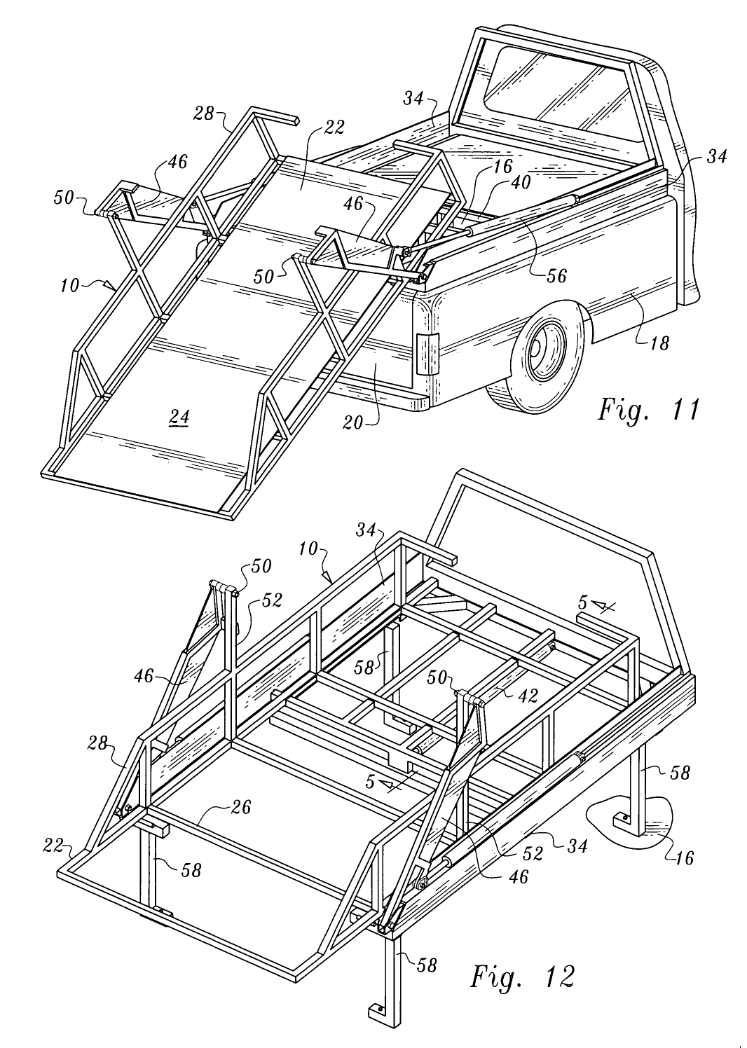

Apparatus 10 includes a carrier 22 having a carrier platform for carrying one or more objects. FIG. 1, for example, shows in phantom an all terrain vehicle supported by the carrier. Where illustrated in FIGS. 1-11, the carrier platform is solid and designated by reference 24. Solid platform 24 is located over another platform comprising an open framework 26, the solid carrier platform having been removed therefrom in FIG. 12 but normally supported thereby when in position. A barrier 28 extends upwardly from platforms 24, 26 and partially surrounds the same.

A transport assembly 30 attached to the pick-up truck is operatively associated with the carrier 22 to move the carrier along with any objects on the carrier between a first carrier position (shown in FIG. 1 for example) to a second carrier position. As will be explained in greater detail below, the second carrier position can be that illustrated in FIG. 7 wherein the carrier is fully separated from the pick-up truck and positioned fully on the ground or other surface support surface behind the pick-up truck or that shown in FIG. 11 wherein the carrier is in an inclined condition between the support surface and the pick-up truck.

In the above-described first carrier position, the carrier, along with any objects thereon, is located above the bed and cargo compartment of the pick-up truck, elevated relative to the bed and positioned relative to the tailgate allowing the tailgate to be opened to provide access to the cargo compartment in a normal manner or to be closed.

In either of the second carrier positions described above, the carrier 22 along with any objects thereon is displaced in a rearward direction relative to the pick-up truck to uncover the cargo compartment and position the carrier on the ground or other surface rearwardly of the pick-up truck.

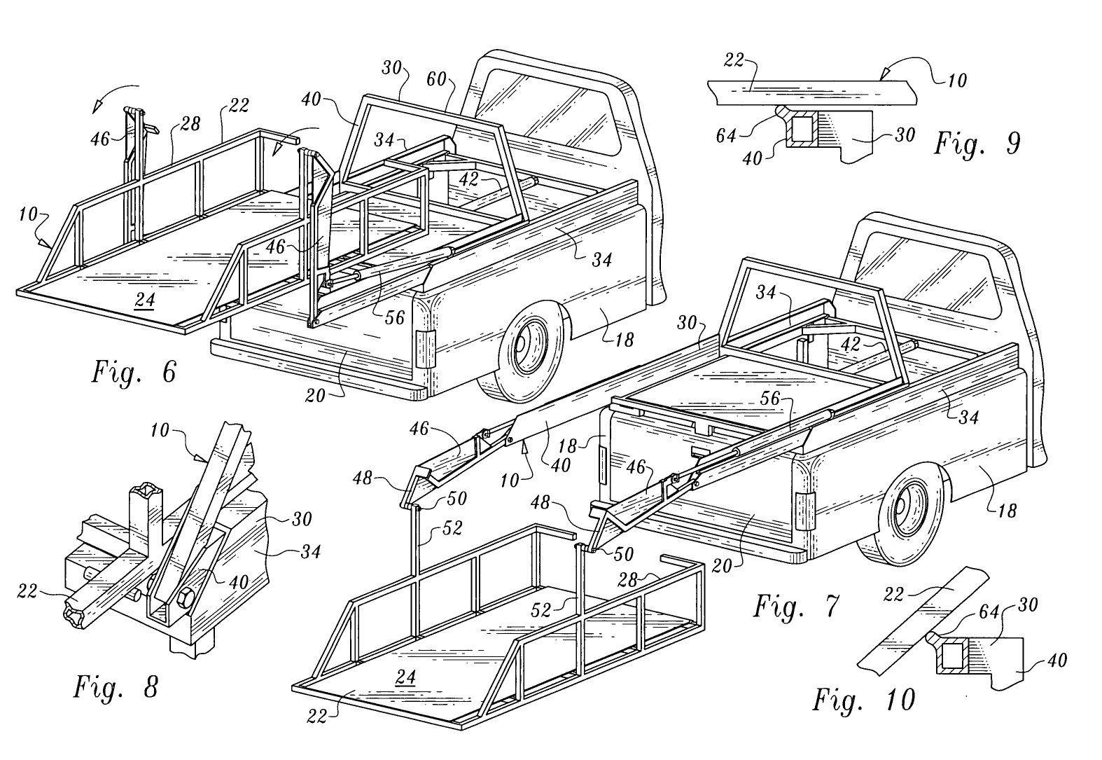

The transport assembly includes a pair of spaced support rails 34 which are elevated relative to the bed of the pick-up truck and extend along the sidewalls 18 thereof when the transport assembly is attached to the pick-up truck. The transport assembly 30 further includes a transport assembly base 40 which is connected to the support rails 34, extending therebetween, and movable along the rails. A transport assembly base mover comprises a fluid operated cylinder device, such as hydraulic cylinder 42, which moves the transport assembly base 40 both forwardly and rearwardly, as desired. That is, the transport assembly base moves between an extended position, shown for example in FIGS. 6 and 7, and a retracted position, shown for example in FIG. 1. It will be noted that the transport assembly base when in its extended position extends over the tailgate when the tailgate is closed. Likewise, the transport assembly base does not interfere with normal operation of the tailgate, as mentioned above, when the carrier is in the position shown in FIG. 1.

The transport assembly also includes support arms 46 having proximal ends pivotally connected to the transport assembly base 40 at spaced locations on the transport assembly base. Distal ends 48 of the support arms are pivotally connected to carrier 22 by pivot pins 50 extending between the support arm distal ends and elongated support members 52 of the carrier. The pivot pins are selectively removable so that the carrier can be completely disconnected from the transport assembly.

Support arm mover structure is operatively associated with the support arms for pivoting the support arms relative to the transport assembly base. More particularly, the support arm mover structure comprises two fluid operated cylinder devices in the nature of hydraulic cylinders 56 (only one of which is illustrated). Each hydraulic cylinder extends between and interconnects the transport assembly base to a support arm and the cylinders are movable with the transport assembly base when the transport assembly base moves between its extended position and its retracted position.

The transport assembly 30 is of unitary construction, enabling the transport assembly to be installed on the pick-up truck or removed therefrom as a unit. Also, of course, if the carrier 22 is connected to the transport assembly it too constitutes part of the unit which may be installed or removed as desired in unitary fashion.

In the arrangement illustrated, the transport assembly includes support legs 58 (see FIG. 12) which extend downwardly from the rails to the bed of the pick-up truck for attachment to the bed by suitable fasteners (not shown). Of course, other types of attachment mechanisms may be employed.

When the hoist and transport apparatus 10 is installed on the pick-up truck the rails of the illustrated embodiment are positionable over and in engagement with upper ends of the sidewalls of the pick-up truck.

In FIG. 1, the transport apparatus is in condition for transport of whatever object or objects are supported by the carrier. In the arrangement illustrated, the transport assembly base includes upstanding guard structure 60 positioned between the cab of the pick-up truck and the carrier to afford protection for the cab.

FIG. 2 illustrates the initial step employed when displacing the carrier 22 from its FIG. 1 position. In this intermediate stage the hydraulic cylinders 56 have been actuated to pivot the support arms 46 from the positions shown in FIG. 1 to the positions shown in FIG. 2 as indicated by the curved arrows in FIG. 1. FIG. 3 provides an illustration of two alternative positions assumed by the distal end 48 of one of the support arms during its operational movement, the solid line depiction showing the positioning of the distal end when the support arm is in the position shown in FIG. 1. It is to be noted that a stop member 62 projects inwardly from the distal end, such stop member engageable with elongated support member 52 to limit forward movement of the carrier when positioned on the pick-up truck, an additional safety feature.

After the carrier has been elevated as shown in FIG. 2, the hydraulic cylinder 42 is actuated to move the transport assembly base and support arms rearwardly relative to the pick-up truck. Once the transport assembly base 40 has been moved rearwardly, the hoist and transport apparatus components have the relative positions shown in FIG. 6.

Next, the hydraulic cylinders 56 are again actuated to be further extended. This results in the support arms being moved to the fully rearwardly projecting positions shown in FIG. 7 wherein the carrier has completely uncovered the cargo compartment and is fully positioned on the ground rearwardly of the pick-up truck. If desired, the pivot pins 50 may be removed to leave the carrier and any objects thereon in position on the ground.

It will be appreciated that return of the carrier to its position over the cargo compartment of the pick-up truck is accomplished by reversing the steps just described.

The operator may encounter situations wherein it is desirable to have the carrier platform inclined between the ground or other support surface and the pick-up truck, a condition illustrated in FIG. 11. To accomplish this, the transport assembly base 40 remains in its initial position and movement of the carrier is accomplished solely by the movement of support arms 46 caused by hydraulic cylinders 56. When the carrier is in the orientation shown in FIG. 11, it essentially operates as a ramp between the truck and the ground. A cross-member 64 of the transport assembly base provides support for the inclined carrier as shown in FIG. 10 as well as support for the carrier when it is over the storage compartment as shown in FIG. 9.

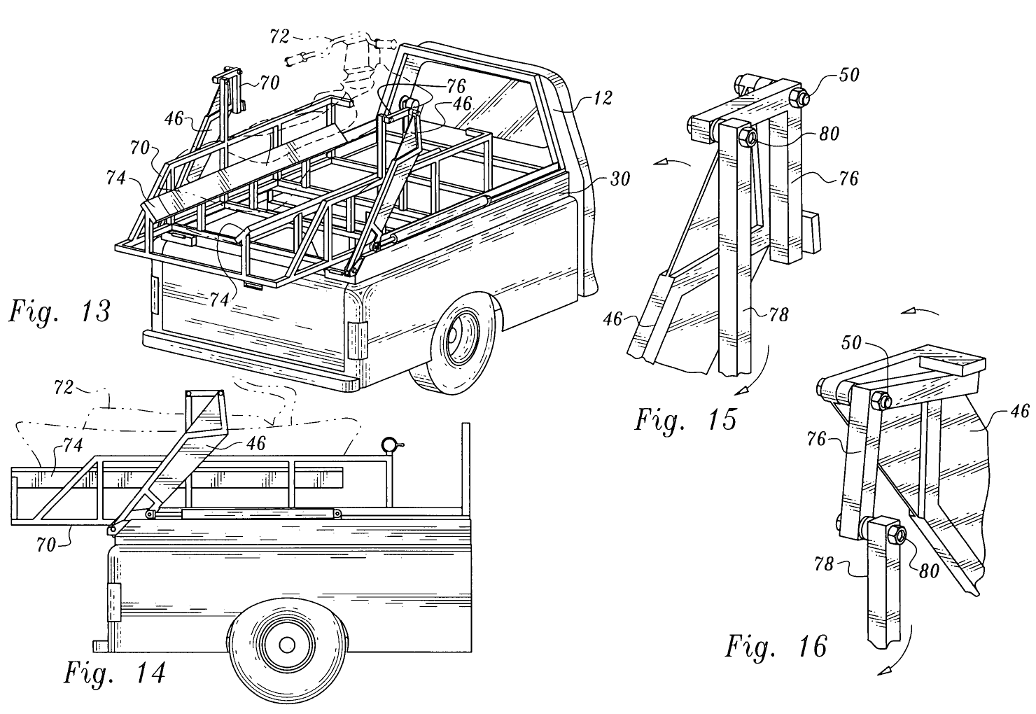

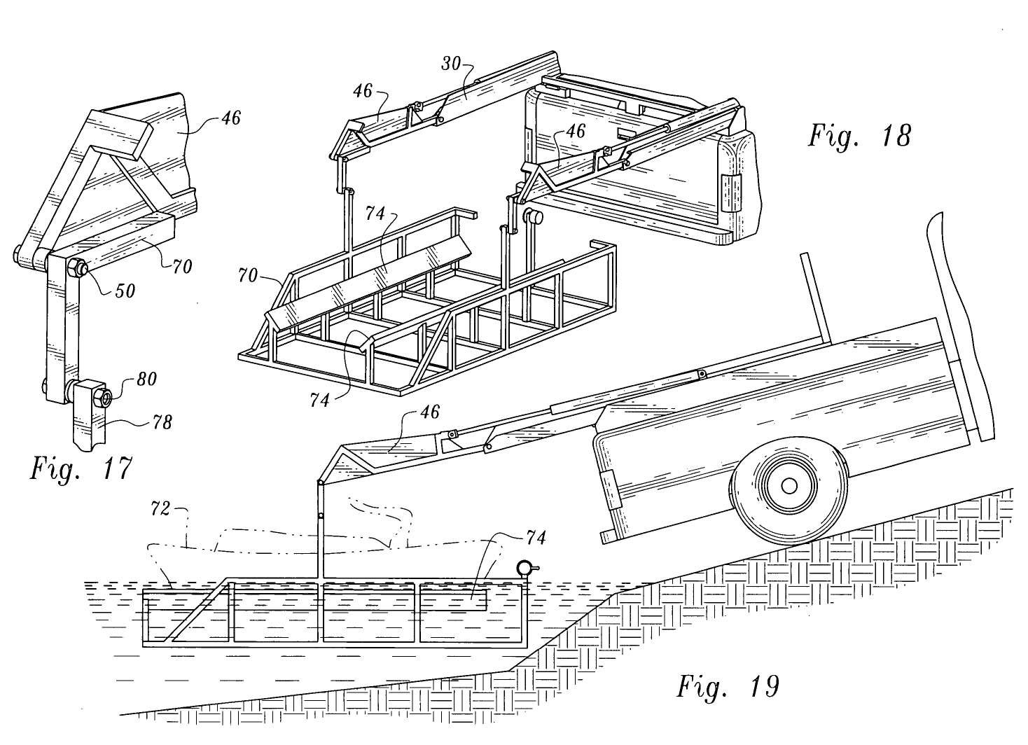

FIGS. 13-19 illustrate a second embodiment of the invention wherein the solid carrier platform is not employed. The transport assembly 30 of the hoist and transport apparatus of this second embodiment is the same as that previously described, only the carrier being modified. That is to say that the transport assembly is adaptable for use with different configurations and types of carriers utilized for different purposes. This is accomplished simply by removing the pivot pins 50 to disconnect one type of carrier and reinstalling them to connect a different type of carrier.

In the second embodiment, the carrier 70 is shown as being utilized to hoist and transport a personal watercraft 72, the latter being shown in phantom lines. The carrier 70 differs from carrier 22 of the first embodiment in several respects, including the incorporation therein of elongated stabilizers 74 utilized to stabilize the watercraft relative to the carrier. The interconnection between the support arms 46 and the carrier 70 is also somewhat different, the carrier incorporating an L-shaped crank arm 76 pivotally connected to the support arm distal end by pivot pin 50. The elongated support members 78 of the carrier 70 are pivotally connected to one of the arms of crank arm 76 by pivot pins 80.

FIGS. 15-17 show the operation of this arrangement as the arm is pivoted from its forwardmost position to its rearmost position. As will be seen in FIGS. 18 and 19, such an arrangement allows the carrier 70 to be dropped to a lower position relative to the pick-up truck than is the case with the interconnection of the first embodiment described above. FIG. 19 shows the carrier platform submerged in a body of water to either launch or retrieve the watercraft 72.

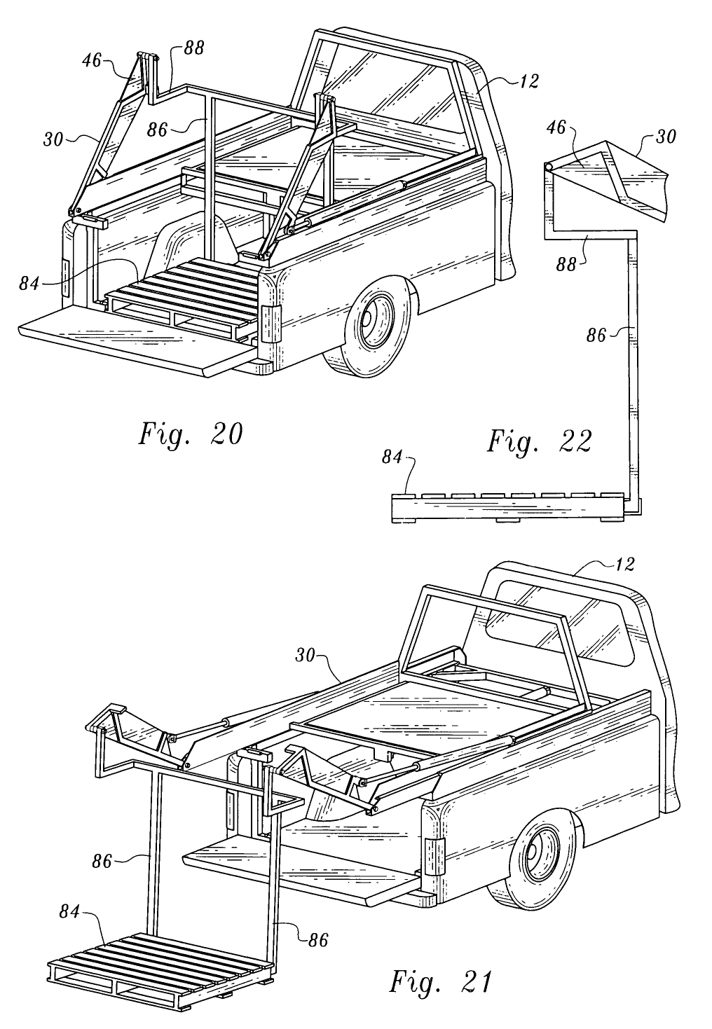

FIGS. 20-22 show another type of carrier that may be employed with the transport assembly. In this arrangement, the carrier comprises a simple platform 84 having two elongated support members 86 extending upwardly therefrom. Structural offset members 88 extend rearwardly of the elongated support members and are connected at their upper ends to the support arm distal ends at locations over the platform.

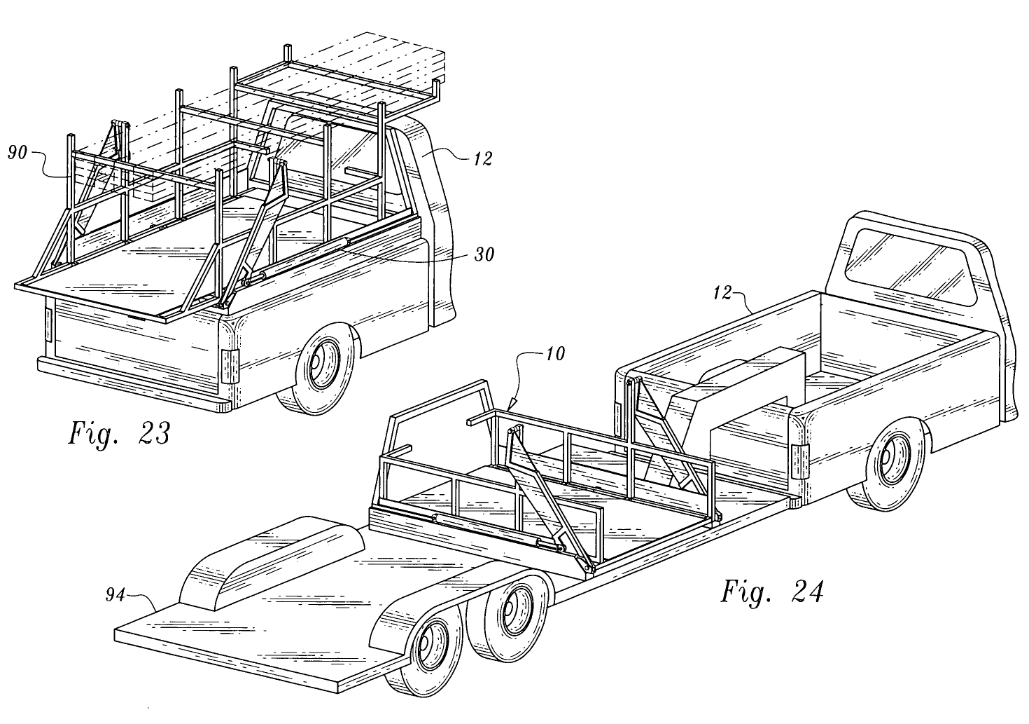

FIG. 23 shows a fourth carrier embodiment 90 which may for example be utilized to carry lumber or other elongated types of goods. Again, the transport assembly 30 components are the same as previously described.

FIG. 24 shows an arrangement wherein the pick-up truck 12 is associated with a trailer 94 utilized to haul the hoist and transport apparatus 10.

The invention claimed is:

1. Hoist and transport apparatus for use with a pick-up truck having a bed, a pair of spaced side walls extending upwardly from said bed and a tail gate defining a pick-up truck cargo compartment, said hoist and transport apparatus comprising, in combination:
a carrier including a carrier platform for carrying one or more objects; and
a transport assembly attachable to the pick-up truck operatively associated with said carrier when said transport assembly is attached to the pick-up truck to move said carrier along with any objects on said carrier between a first carrier position wherein said carrier along with any objects thereon is located above the bed and cargo compartment of the pick-up truck, elevated relative to the bed and positioned relative to the tail gate allowing the tail gate to be opened to provide access to the cargo compartment or to be closed and a second carrier position wherein said carrier along with any objects thereon is displaced in a rearward direction relative to the pick-up truck to uncover the cargo compartment and position the carrier on the ground or other surface rearwardly of the pick-up truck, said transport assembly including a pair of spaced support rails elevated relative to the bed of the pick-up truck and extending along the sidewalls thereof when said transport assembly is attached to the pick-up truck.

2. The hoist and transport apparatus according to claim 1 wherein said transport assembly further includes a transport assembly base connected to the support rails and movable along said rails and a transport assembly base mover operatively associated with said transport assembly base for moving said transport assembly base between an extended position and a retracted position, said transport assembly base when in said extended position extending over the tail gate when the tail gate is closed.

3. The hoist and transport apparatus according to claim 2 wherein said transport assembly base mover comprises a fluid operated cylinder device.

4. The hoist and transport apparatus according to claim 2 wherein said transport assembly additionally includes support arms having proximal ends pivotally connected to said transport assembly base at spaced locations on said transport assembly base and distal ends connected to said carrier.

5. The hoist and transport apparatus according to claim 4 wherein said transport assembly additionally includes support arm mover structure operatively associated with said support arms for pivoting said support arms relative to said transport assembly base.

6. The hoist and transport apparatus according to claim 5 wherein said support arm mover structure comprises at least one fluid operated cylinder device.

7. The hoist and transport apparatus according to claim 6 wherein said at least one fluid operated cylinder device extends between and interconnects said transport assembly base and said support arms, said at least one fluid operated cylinder device movable with said transport assembly base when said transport assembly base moves between said extended position and said retracted position.

8. The hoist and transport apparatus according to claim 4 wherein the distal ends of said support arms are pivotally connected to said carrier by pivot pins.

9. The hoist and transport apparatus according to claim 8 wherein said pivot pins are selectively removable pivot pins whereby said carrier can be readily disconnected from said transport assembly.

10. The hoist and transport apparatus according to claim 5 wherein said at least one support arm mover structure comprises a pair of fluid operated cylinder devices, one of said fluid operated cylinder devices being connected to a first support arm to pivot said first support arm and the other of said fluid operated cylinder devices being connected to a second support arm to pivot said second support arm.

11. The hoist and transport apparatus according to claim 1 wherein said carrier platform is substantially solid.

12. The hoist and transport apparatus according to claim 1 wherein said carrier platform comprises an open framework.

13. The hoist and transport apparatus according to claim 1 wherein said transport assembly is of unitary construction, enabling said transport assembly to be installed on the pick-up truck or removed from the pick-up truck as a unit.

14. The hoist and transport apparatus according to claim 13 wherein said transport assembly includes support legs extending downwardly from said rails to the bed of the pick-up truck for attachment to the bed.

15. The hoist and transport apparatus according to claim 14 wherein said rails are positionable over and for engagement with upper ends of the sidewalls of the pick-up truck.

16. The hoist and transport apparatus according to claim 1 wherein said carrier is one of a plurality of different configurations of carriers selectively alternatively releasably connectable to said transport assembly.

17. The hoist and transport apparatus according to claim 1 wherein said carrier includes a barrier extending upwardly from and at least partially surrounding said carrier platform.

18. The hoist and transport apparatus according to claim 2 wherein said transport assembly base includes upstanding guard structure for positioning between the cab of the pick-up truck and the carrier.

19. The hoist and transport apparatus according to claim 1 wherein said carrier includes stabilizers engageable with the hull of a watercraft to stabilize the watercraft relative to the carrier.

20. The hoist and transport apparatus according to claim 2 wherein said transport assembly base includes a cross-member located between the support rails of said pair of support rails for engaging and supporting the bottom of said carrier.

21. The transport assembly according to claim 2 wherein said transport assembly is cooperable with said carrier to selectively alternatively fully separate said carrier from said transport assembly base and the pick-up truck or position the carrier simultaneously in engagement with a support surface rearwardly of the pick-up truck and the transport assembly base to maintain the carrier platform in an inclined condition between the support surface and the pick-up truck.

22. The hoist and transport apparatus according to claim 4 wherein said transport assembly additionally comprises a stop on at least one support arm engageable by said carrier to restrict movement of said carrier when said carrier is in said first carrier position.

23. The hoist and transport apparatus according to claim 4 wherein said carrier includes pivotal connector linkage extending to the distal ends of said support arms.

24. The hoist and transport apparatus according to claim 23 wherein said pivotal connector linkage comprises a crank arm pivotally connected to each support arm and pivotally connected to said carrier.
